(19) United States
(12) Patent Application Publication
(10) Pub. No.: US 2026/0329202 A1
(43) Pub. Date: Oct. 22, 2026

(54) IMAGE FORMING APPARATUS

(71) Applicant: CANON KABUSHIKI KAISHA, Tokyo (JP)

(72) Inventors: Kazuki Matsumoto, Shizuoka (JP); Hiroomi Matsuzaki, Shizuoka (JP); Hideto Chino, Kanagawa (JP)

(21) Appl. No.: 19/636,116

(22) Filed: Apr. 1, 2026

(30) Foreign Application Priority Data
Apr. 21, 2025 (JP) 2025-069555

(51) Int. Cl. G03G 15/08; G03G 21/20

(52) U.S. Cl. CPC G03G 15/0891; G03G 15/0889; G03G 21/206; G03G 2221/1645

(57) ABSTRACT

An image forming apparatus includes: a first pump that is able to be brought into a first air intake state and a first exhaust state between a developer accommodating portion and a discharge port; and a second pump that is connected to a conveyance passage between the discharge port and a developing unit and is able to communicate with external air, and an amount of air flow per unit time fed by the second pump in the second exhaust state to the conveyance passage is smaller than an amount of air flow per unit time fed by the first pump in the first exhaust state to the conveyance passage in a developer supply operation from the developer accommodating portion to the developing unit by the first pump repeating its exhaust and intake state and by the second pump repeating intake-exhaust-intake cycle.

### BACKGROUND

### Field of the Technology

The present disclosure relates to an image forming apparatus of an electrophotographic system.

### Description of the Related Art

A configuration of an electrophotographic image forming apparatus in which a toner storage unit accommodating a toner (developer) to be used for image formation and a developing unit for performing an electrophotographic process are removably mounted in an apparatus main body is widely known. Japanese Patent Application Publication No. 2007-249151 discloses, as a configuration for supplying a toner from a toner storage unit to a developing unit, a configuration of conveying a toner by an air flow formed by a pump.

Here, the toner may stagnate in a conveyance passage from the toner storage unit to the developing unit. Fluidity of the toner stagnating in the conveyance passage may decrease by being left for a long period of time or by being exposed to a high temperature, for example. If the toner with reduced fluidity stagnates in the toner conveyance passage, then variations such as a decrease in amount of toner to be supplied thereafter may occur, a necessary amount of toner may not be supplied to the developing unit, and there may be a concern of an image failure.

### SUMMARY

The present disclosure is directed to provide a technology capable of curbing occurrence of an image failure.

In order to solve the above problem, an image forming apparatus according to the present disclosure includes:
a developer storage unit that includes a developer accommodating portion and a discharge port that discharges developer accommodated in the developer accommodating portion;
an image bearing member on which an electrostatic latent image is formed;
a developing unit that develops the electrostatic latent image using the developer supplied from the developer storage unit; a conveyance passage that connects the discharge port and the developing unit;
a first pump that is connected to the developer storage unit and discharges, to the developer storage unit, air for discharging the developer from the developer storage unit to the conveyance passage via the discharge port; and
a second pump that is connected between the discharge port and the developing unit in the conveyance passage and discharges air to the conveyance passage, wherein
the developer discharged to the conveyance passage together with the air discharged from the first pump is conveyed to the developing unit through inside of the conveyance passage together with the air discharged from the second pump, and
in a case where the developer is conveyed to the developing unit, an amount of air discharged from the second pump is smaller than an amount of air discharged from the first pump.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an image forming apparatus according to a first embodiment.

FIG. 2 is a sectional view of a developing unit according to the first embodiment.

FIG. 3 is a sectional view of a toner storage unit in a direction Z2 according to the first embodiment.

FIG. 4 is a sectional view of the toner storage unit in a direction X2 according to the first embodiment.

FIG. 5 is a perspective view of a drive part for a first pump according to the first embodiment.

FIG. 6A is a sectional view illustrating an expanding operation of the first pump according to the first embodiment.

FIG. 6B is a sectional view illustrating a contracting operation of the first pump according to the first embodiment.

FIG. 7A is a sectional view in a state where the expanded first pump and a toner accommodating portion are connected according to the first embodiment.

FIG. 7B is a sectional view in a state where the contracting first pump and the toner accommodating portion are connected according to the first embodiment.

FIG. 8A is a schematic view at the time of waiting of a second pump (stopping of the pump) according to the first embodiment.

FIG. 8B is a schematic view at the time of air intake of the second pump according to the first embodiment.

FIG. 8C is a schematic view at the time of exhaust of the second pump according to the first embodiment.

FIG. 9 is a sectional view of a toner conveyance passage and the second pump according to the first embodiment.

FIG. 10 is a sectional view of the toner storage unit and the developing unit according to the first embodiment.

FIG. 11 is a graph showing static pressures in volume changed states of the first pump and the second pump.

FIG. 12 is a relationship diagram of a ventilation resistance of a ventilation member and the second pump when a first valve and a second valve are in an opened state.

FIG. 13 is a conceptual diagram of operation timings of the first pump and the second pump according to the first embodiment.

FIG. 14A is a sectional view when the first pump is stopped and the second pump is performing an expanding operation according to the first embodiment.

FIG. 14B is a graph illustrating relationships between static pressures at the first pump and the second pump in a first pump state, a tree-way intersection portion of the toner conveyance passage, and the toner storage unit, and near a ventilation member of the toner conveyance passage and an atmospheric pressure.

FIG. 15A is a sectional view when the first pump is stopped and the second pump is performing the contracting operation according to the first embodiment.

FIG. 15B is a graph illustrating relationships between static pressures at the first pump and the second pump in a second pump state, the three-way intersection portion of the toner conveyance passage, and the toner storage unit, and near the ventilation member of the toner conveyance passage and the atmospheric pressure.

FIG. 16A is a sectional view when the first pump is performing the expanding operation and the second pump is performing the expanding operation according to the first embodiment.

FIG. 16B is a graph illustrating relationships between static pressures at the first pump and the second pump in a third pump state, the three-way intersection portion of the toner conveyance passage, and the toner storage unit, and near the ventilation member of the toner conveyance passage and the atmospheric pressure.

FIG. 17A is a sectional view when the first pump is performing the expanding operation and the second pump is performing the contracting operation according to the first embodiment.

FIG. 17B is a graph illustrating relationships between static pressures at the first pump and the second pump in a fourth pump state, the three-way intersection portion of the toner conveyance passage, and the toner storage unit, and near the ventilation member of the toner conveyance passage and the atmospheric pressure.

FIG. 18A is a sectional view when the first pump is performing the contracting operation and the second pump is performing the expanding operation according to the first embodiment.

FIG. 18B is a graph illustrating relationships between static pressures at the first pump and the second pump in a fifth pump state, the three-way intersection portion of the toner conveyance passage, and the toner storage unit, and near the ventilation member of the toner conveyance passage and the atmospheric pressure.

FIG. 19A is a sectional view when the first pump is performing the contracting operation and the second pump is performing the contracting operation according to the first embodiment.

FIG. 19B is a graph illustrating relationships between static pressures at the first pump and the second pump in a sixth pump state, the three-way intersection portion of the toner conveyance passage, and the toner storage unit, and near the ventilation member of the toner conveyance passage and the atmospheric pressure.

### DESCRIPTION OF THE EMBODIMENTS

Hereinafter, embodiments of the present disclosure will be described in detail on the basis of embodiments with reference to the drawings. In this regard, the dimensions, materials, shapes, relative arrangements, and the like of the components described in the embodiments may be appropriately modified according to the configurations and various conditions of apparatuses to which the present disclosure is applied. That is, the scope of the present disclosure is not intended to be limited to the embodiments described below. Furthermore, while a plurality of features are described in the embodiments, all of the plurality of features are not necessarily essential to the disclosure, and the plurality of features may be combined with each other in any way. Moreover, in the accompanying drawings, the same reference numerals are assigned to the same or similar components, and redundant descriptions thereof are omitted.

### First Embodiment

An example in which the present disclosure is applied to an image forming apparatus of an electrophotographic system will be described as a first embodiment. An image forming apparatus IF according to the first embodiment is a laser beam printer of an electrophotographic system and is adapted to form an image with a developer (toner) on a sheet S, which is a recording medium, in accordance with image information transmitted from an external device such as a personal computer. However, the scope to which the present disclosure can be applied is not limited to the image forming apparatus according to the following embodiment, and the present disclosure can also be applied to image forming apparatuses such as a copy machine, a printer, a multifunction device, and a commercial printing apparatus. As examples of the recording medium, sheet materials of various materials and with various shapes, such as paper including plain paper and thick paper, a plastic film, coated paper, a sheet in a special form such as an envelope or index paper, and a cloth, are used.

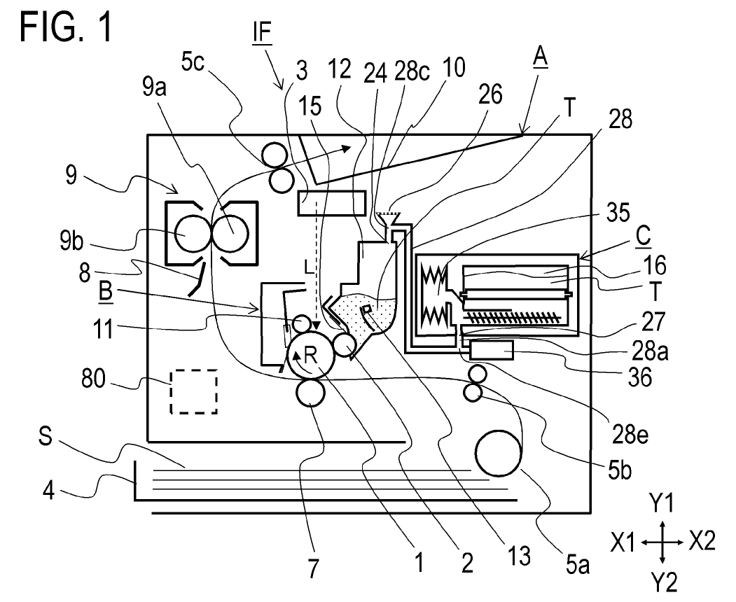

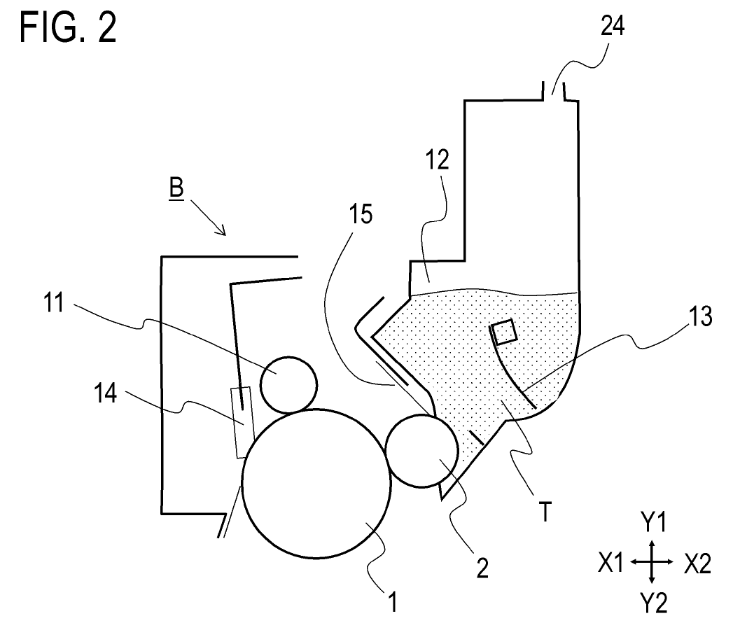

FIG. 1 is a schematic view illustrating a sectional configuration of the image forming apparatus IF according to the first embodiment of the present disclosure, and FIG. 2 is a sectional view of a developing unit B. As illustrated in FIG. 1, the developing unit B and a toner storage unit C (developer storage unit) are installed in an apparatus main body A of the image forming apparatus IF and form an image on the sheet S, which is a recording medium. The apparatus main body A is a part of the image forming apparatus IF except for the developing unit B and the toner storage unit C.

In the embodiment, the developing unit B and the toner storage unit C are configured to be removably attachable to the apparatus main body A. However, the present disclosure is not limited to the configuration, and it is also possible to obtain a similar effect even with a configuration in which the developing unit B and the toner storage unit C are fastened to the apparatus main body A.

The direction in which the image forming apparatus IF is set up on a horizontal surface as a normal set-up state and takes a posture for utilization is defined as follows. The upper direction of the vertical direction illustrated as a Y axis is defined as a direction Y1, and the lower direction is defined as a direction Y2. The left direction of the horizontal left-right direction in FIG. 1 illustrated as an X axis is defined as a direction X1, and the right direction is defined as a direction X2. The closer direction of the horizontal depth direction in FIG. 1 illustrated as a Z axis is defined as a direction Z1, and the further direction is defined as a direction Z2. FIG. 1 is a sectional view when the image forming apparatus IF is seen in the direction Z2.

In the present embodiment, the entire image forming apparatus IF, and configurations of the developing unit B, the toner storage unit C, the first pump 35, and the second pump 36 will be described. Thereafter, flows of air and a toner T (developer) at the time of conveyance of the toner T and states of the first pump 35 and the second pump 36 will be described.

### Overall Configuration of Image Forming Apparatus

As illustrated in FIG. 1, the image forming apparatus IF according to the present embodiment is an electrophotographic laser beam printer. The apparatus main body A includes, in addition to the installation parts of the developing unit B and the toner storage unit C, a pickup roller 5a, a conveyance roller pair 5b, a transfer roller 7, a fixing device 9, a discharge roller pair 5c, and a discharge tray 10 in a direction in which the sheet S is conveyed from the sheet tray 4. The image forming apparatus IF includes a control portion 80 that controls operations of each component. The control portion 80 can be configured by a computer including a processor, a memory, a storage, and an I/O, for example.

### Image Forming Process

Once the image forming apparatus IF receives a signal to start image formation on the sheet S, a photosensitive drum 1 (an image bearing member) is driven to rotate in the direction of the arrow R in FIG. 1. A charging roller 11 comes into contact with the outer peripheral surface of the photosensitive drum 1 to uniformly and evenly charge the surface of the photosensitive drum 1. A laser scanner 3 performs an exposure operation of irradiating the photosensitive drum 1 with a laser beam L based on image information and writing an electrostatic latent image on the surface of the photosensitive drum 1.

The toner T accommodated in a toner chamber 12 is fed to the developing roller 2 by a developing stirring member 13. The toner T is then supplied to the developing roller 2 and is carried as a thin layer on the surface of the developing roller 2 by a developing blade 15. The toner T that has reached a developing zone where the developing roller 2 and the photosensitive drum 1 face each other is transferred from the developing roller 2 to the surface of the photosensitive drum 1 according to a potential distribution on the surface of the photosensitive drum 1. Thus, the electrostatic latent image on the surface of the photosensitive drum 1 is visualized as a toner image.

In parallel with such a process, the sheet S is fed at the timing synchronized with the exposure operation of the laser scanner 3. The pickup roller 5a feeds the sheet S placed on the sheet tray 4 from the sheet tray 4. The conveyance roller pair 5b receives the sheet S from the pickup roller 5a and conveys the sheet S to a transfer portion between the photosensitive drum 1 and the transfer roller 7. Thereafter, a bias voltage is applied to the transfer roller 7, and the toner image carried on the photosensitive drum 1 is thus transferred to the sheet S.

The sheet S with the toner image transferred thereon is conveyed to the fixing device 9 along a conveyance guide 8. The fixing device 9 applies heat and a pressure to the toner image on the sheet S by a heat roller 9a and a pressure roller 9b to thereby fix the image on the sheet S. The sheet S on which the image has been fixed is discharged to the discharge tray 10, which is provided at an upper portion of the apparatus main body A, by the discharge roller pair 5c.

### Developing Unit

Referring to FIG. 2, an overview of the configuration of the developing unit B will be described below. FIG. 2 is a sectional view of the developing unit B in the direction Z2.

The developing unit B of the present embodiment includes a receiving port 24 that receives the toner T supplied from the toner storage unit C, in addition to the photosensitive drum 1, the charging roller 11, the developing roller 2, the developing blade 15, and the toner chamber 12 described above.

### Toner Storage Unit

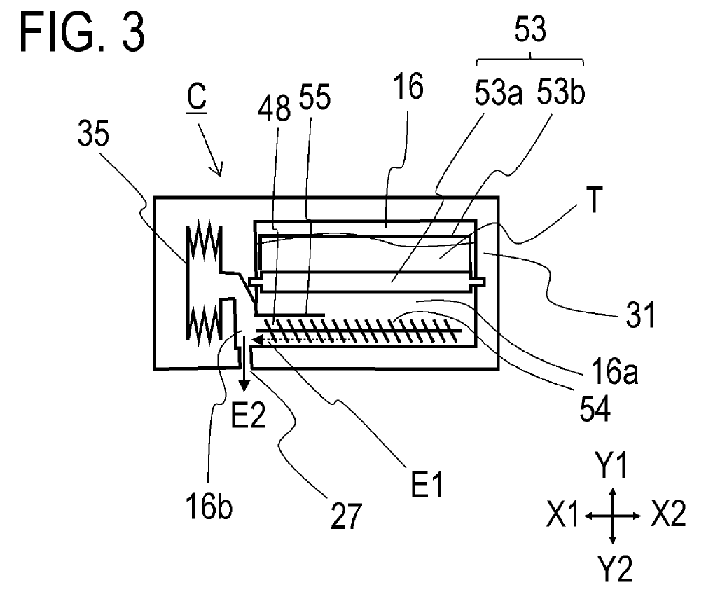

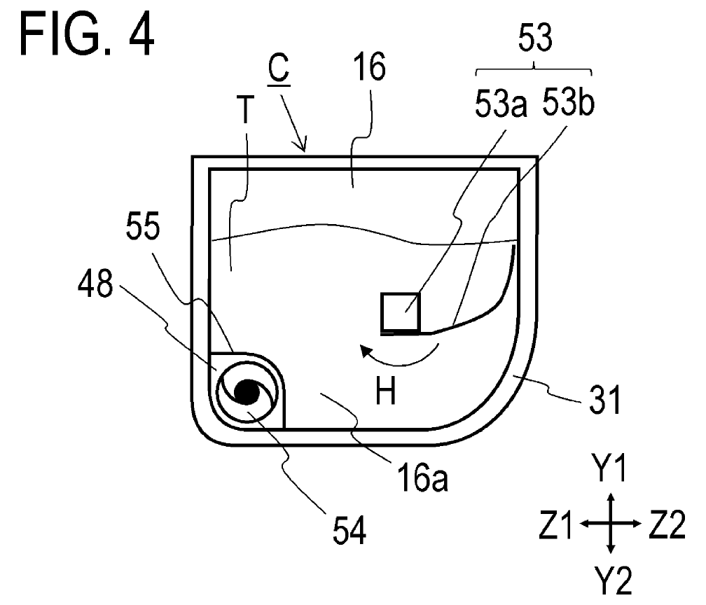

An overview of the configuration of the toner storage unit C will be described using FIGS. 3 and 4. FIG. 3 is a sectional view of the toner storage unit C in the direction Z2. FIG. 4 is a sectional view of the toner storage unit C in the direction X2.

As illustrated in FIG. 3, a toner accommodating portion 16 (developer accommodation portion) and a first pump 35 are disposed in the toner storage unit C. The toner accommodating portion 16 is a space surrounded by a frame body 31 and is connected to the first pump 35. Also, the toner accommodating portion 16 accommodates the toner T therein and includes a stirring member 53, a screw 54, a partitioning wall 55, a communication passage 48, a toner chamber 16a, a toner discharge chamber 16b, and a discharge port 27. Furthermore, the toner accommodating portion (accommodating chamber) 16 is partitioned into a plurality of spaces by the partitioning wall 55, such that the toner chamber 16a, the communication passage 48 and the toner discharge chamber 16b are formed.

In the present embodiment, a bellows pump is used as the first pump 35. The bellows pump has a bellows (accordion-shaped) portion as a first volume changing portion, and the volume inside the pump is changed by the accordion-shaped portion expanding and contracting to thereby perform air intake and exhaust. Note that the pump to be used is not limited to the bellows pump as long as it has a configuration of performing air intake and exhaust using a change in volume of the pump and may be another pump such as a piston pump or a plunger pump. Furthermore, although the first pump 35 is disposed in the toner storage unit C, it may be disposed in the apparatus main body A.

The stirring member 53 is connected to be driven by a drive source (not illustrated) of the apparatus main body A and is rotatably supported by the frame body 31. Also, the stirring member 53 includes a rotation shaft 53a and a replenishing and stirring sheet 53b as a conveyance member which is a flexible sheet. The screw 54 is a conveyance member that conveys the toner T to the communication passage 48 and the toner discharge chamber 16b along the rotation axis. The rotation axis of the screw 54 and the rotation axis of the stirring member 53 are disposed to be substantially parallel to each other. The communication passage 48 is a space for establishing communication between the toner chamber 16a and the toner discharge chamber 16b, and the toner T moves therein. At least a part of the screw 54 is disposed inside the communication passage 48. The toner discharge chamber 16b is disposed on the side further downstream than the communication passage 48 in the conveyance direction in which the screw 54 conveys the toner T. Also, the toner discharge chamber 16b includes a discharge port 27. The discharge port 27 is an opening for establishing communication between the inside and the outside of the frame body 31 and discharging the toner T to the outside (the direction of the arrow E2) of the frame body 31.

A mechanism of conveying the toner T inside the toner storage unit C will be described using FIGS. 3 and 4.

As illustrated in FIG. 4, the toner storage unit C receives a drive force from the apparatus main body A, the rotation shaft 53a drives, and the stirring sheet 53b rotates in the direction of the arrow H, thereby sending the toner T to the screw 54. Then, the toner T is caused to pass through the communication passage 48 and is conveyed to the toner discharge chamber 16b by the screw 54 (the direction of the dotted line arrow E1) as illustrated in FIG. 3. The partitioning wall 55 forming the communication passage 48 is formed to have an inner diameter corresponding to the outer diameter of the screw 54. With such a configuration, the toner T conveyed by the screw 54 is struck by the inner diameter of the communication passage 48, and a constant amount of toner T can constantly be conveyed to the toner discharge chamber 16b located downstream in the toner conveyance direction.

### First Pump

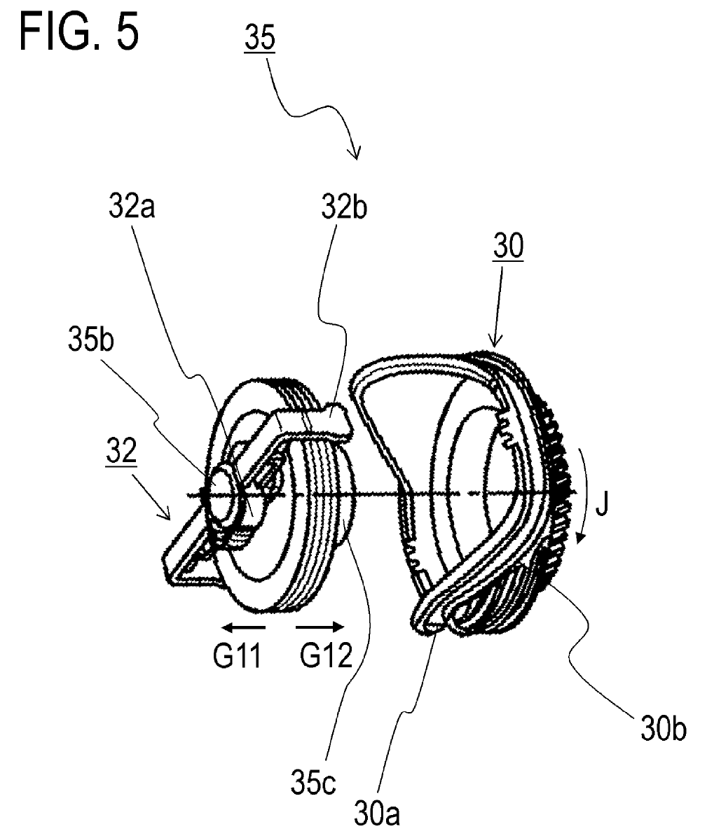

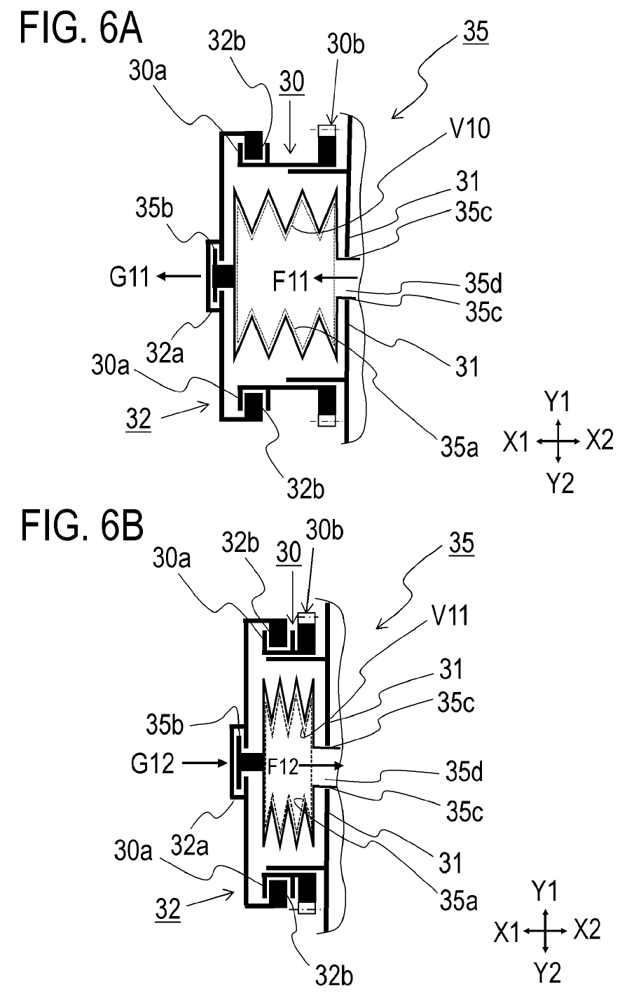

A configuration of the first pump 35 performing contracting and expanding operation will be described using FIGS. 5, 6A, and 6B. FIG. 5 is a perspective view of parts of the first pump 35. FIG. 6A is a sectional view in the direction Z2 illustrating the expanding operation of the first pump 35. FIG. 6B is a sectional view in the direction Z2 illustrating the contracting operation of the first pump 35.

First, the configuration of the first pump 35 will be described. As illustrated in FIG. 5, a link gear 30 and a link member 32 are provided as members for performing the contracting and expanding operations of the first pump 35. The link gear 30 has a link groove 30a and a gear portion 30b, and the gear portion 30b receives driving from a drive gear, which is not illustrated, and can rotate in the direction of the arrow J. The link member 32 has an engagement portion 32awith the first pump 35 and an engagement portion 32b with the link groove. The engagement portion 32a is engaged with a pump engagement portion 35b of the first pump 35, and the link engagement portion 32b with the link groove 30a is engaged with the link groove 30a. The link gear 30 can thus slide along the shape of the link groove 30a.

Next, operations of the first pump 35 will be described. As illustrated in FIGS. 6A and 6B, the first pump 35 is fixed to the frame body 31 by a frame body engagement portion 35c and the frame body 31 of the toner storage unit C being engaged with each other. In this manner, an intake/exhaust port 35d of the first pump 35 communicates with the inside of the frame body 31. The link member 32 reciprocates in the direction of the arrow G11 (FIG. 6A) and the direction of the arrow G12 (FIG. 6B) along the link groove 30a by the link gear 30 rotating. In conjunction with this motion, the first pump 35 engaged with the link member 32 repeats expansion (the direction of the arrow G11) and contraction (the direction of the arrow G12). In other words, air intake is performed through the intake/exhaust port 35d when the first pump 35 expands, and exhaust is performed through the intake/exhaust port 35d when the first pump 35 contracts.

Here, the volume V10 when the first pump 35 expands (FIG. 6A) is 20 ml, and the volume V11 when the first pump 35 contracts (FIG. 6B) is 3 ml. Also, the first pump 35 performs expansion and contraction 2.5 times per second.

### Second Pump

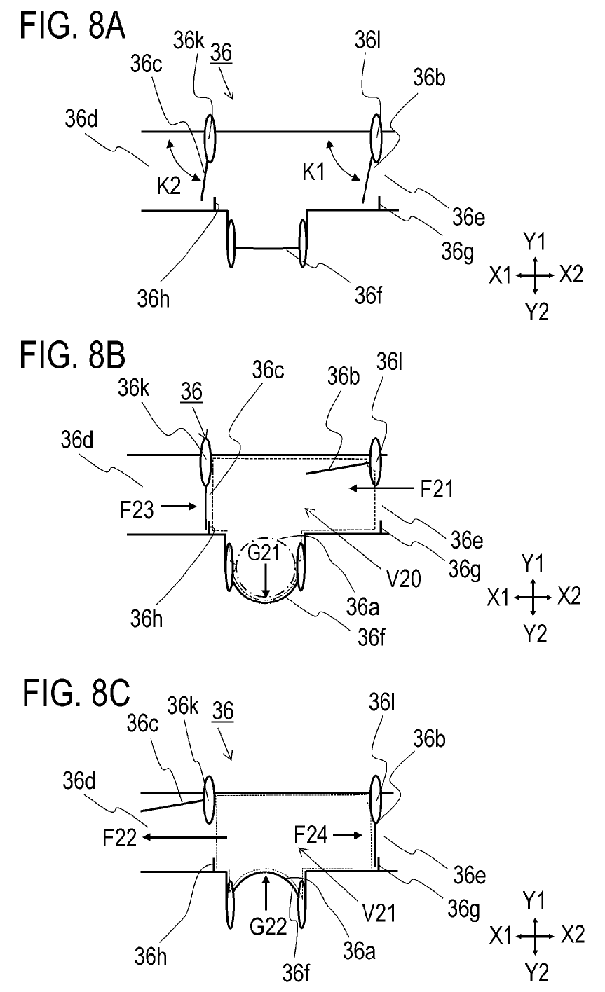

The second pump 36 will be described using FIGS. 8A, 8B, and 8C. FIG. 8A is a schematic view at the time of waiting of the second pump 36 (when the pump is stopped). FIG. 8B is a schematic view at the time of air intake of the second pump 36. FIG. 8C is a schematic view at the time of exhaust of the second pump 36.

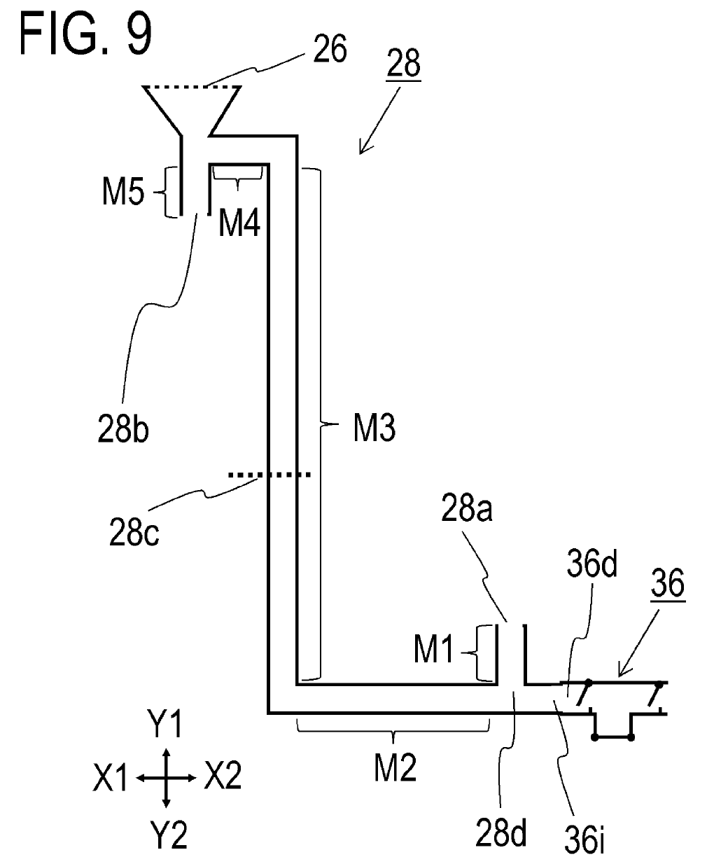

First, the configuration of the second pump 36 will be described. The second pump 36 of the present embodiment is a diaphragm pump as illustrated in FIG. 8A. Specifically, the second pump 36 is configured of a volume changing portion 36a (second volume changing portion), an air intake port 36e, an exhaust port 36d, a first valve 36b, a second valve 36c, a diaphragm 36f, a first stopper portion 36g, and a second stopper portion 36h. The second pump 36 is provided in an external air passage 36i (see FIG. 9) connecting the air intake port 36e opened to the external air and a three-way intersection portion 28d (connecting portion), which will be described later and is configured to be able to communicate the toner conveyance passage 28 to the outside. Here, the first valve 36b and the second valve 36c are supported so as to be swingable in the directions of the arrows K1 and K2 around support points 36l and 36k, respectively. Furthermore, the first stopper portion 36g is provided on the side further outward than the first valve 36b, and the second stopper portion 36h is provided on the side further inward than the second valve 36c, with respect to the volume changing portion 36a. Although this allows the first valve 36b and the second valve 36c to swing in the direction X1 together, the swinging in the direction X2 is restricted by the first stopper portion 36g and the second stopper portion 36h, respectively.

Hereinafter, a state where the first valve 36b abuts on the first stopper portion 36g and is closed as illustrated in FIG. 8C will be referred to as a “closed state”, and a state where the first valve 36b swings in the direction X1 and is opened as illustrated in FIG. 8B will be referred to as an “opened state”. In other words, the first valve 36b closes the external air passage 36i (see FIG. 9) on the side closer to the air intake port 36e than the volume changing portion 36a in the closed state. Also, the first valve 36b is brought into a state where the volume changing portion 36a is caused to communicate with the external air, that is, a state where an intake air flow directed from the air intake port 36e to the volume changing portion 36a can be formed, in the opened state. Similarly, a state where the second valve 36c swings in the direction X1 and is opened as illustrated in FIG. 8C will be referred to as an “opened state”, and a state where the second valve 36c abuts on the second stopper portion 36h and is closed as illustrated in FIG. 8B will be referred to as a “closed state”. In other words, the second valve 36c closes the external air passage 36i (see FIG. 9) on the side closer to the exhaust port 36d (three-way intersection portion 28d) than the volume changing portion 36a in the closed state. Also, the second valve 36c is brought into a state where the volume changing portion 36a is caused to communicate with the toner conveyance passage 28, that is, a state where an exhaust air flow directed from the volume changing portion 36a to the three-way intersection portion 28d (connecting portion) can be formed, in the opened state.

As illustrated in FIGS. 8B and 8C, the volume of the volume changing portion 36a (the part surrounded by the one-dotted chain line) changes by reciprocating in the direction of the arrow G21 (FIG. 8B) and the direction of the arrow G22 (FIG. 8C) of the diaphragm 36f. The air intake port 36e is an opening portion for taking air outside the second pump 36 into the second pump 36, and the exhaust port 36d is an opening portion for exhausting the air taken from the outside from the second pump 36.

An air intake operation of the second pump 36 will be described. Once the diaphragm 36f is displaced in the expanding direction (the direction of the arrow G21) as illustrated in FIG. 8B, then the pressure of the volume changing portion 36a decreases. The first valve 36b is biased in the direction X1, and the second valve 36c is biased in the direction X2 with a force of air flows (the arrow F21 and the arrow F23) flowing toward the volume changing portion 36a due to the decrease in pressure of the volume changing portion 36a. At this time, the first valve 36b is brought into the opened state, and the second valve 36c abuts on the second stopper portion 36h and is thus brought into the closed state. In this manner, the air outside the second pump 36 is taken from the air intake port 36e toward the volume changing portion 36a (the direction of the arrow F21).

The exhausting operation of the second pump 36 will be described. Once the diaphragm 36f is displaced on the contracting direction (the direction of the arrow G22) as illustrated in FIG. 8C, the pressure of the volume changing portion 36a increases. The first valve 36bis biased in the direction X2, and the second valve 36c is biased in the direction X1 with a force of air flows (the arrow F22 and the arrow F24) flowing from the volume changing portion 36a due to the increase in pressure of the volume changing portion 36a. At this time, the first valve 36b abuts on the first stopper portion 36g and is thus brought into the closed state, and the second valve 36c is brought into the opened state. In this manner, the air inside the volume changing portion 36a is exhausted toward the exhaust port 36d (the direction of the arrow F22).

Here, the volume V20 at the time of expansion (FIG. 8B) of the second pump 36 is 2.3 ml, and the volume V21 at the time of contraction (FIG. 8C) is 2 ml. Also, the second pump 36 performs expansion and contraction twenty times per second.

Note that in the present embodiment, the second pump 36 is provided in the apparatus main body A with the exhaust port 36d connected to the conveyance passage 28. However, the present disclosure is not limited to this configuration, and it is also possible to obtain a similar effect even if the second pump 36 is provided in the toner storage unit C, for example.

Although the states of the diaphragm 36f, the first valve 36b, and the second valve 36c in a case where the second pump 36 moves alone have been described hitherto, a case where the first pump 35 and the second pump 36 move in conjunction with each other will be described later in detail.

### Toner Transport Path

An overview of the configuration of the toner conveyance passage 28 for the toner T will be described using FIGS. 1 and 9. FIG. 9 is a sectional view of the toner conveyance passage 28 and the second pump 36 in the direction Z2.

The toner conveyance passage 28 is a tubular hollow member provided in the apparatus main body A. One end of the conveyance passage 28 is a first connecting portion 28a and is connected to the discharge port 27 provided at the toner accommodating portion 16. The other end is a second connecting portion 28b and communicates with the receiving port 24 of the developing unit B. Here, with reference to an intermediate point (dotted line 28c) of the toner conveyance passage 28, the second pump 36 is disposed on the side closer to the discharge port 27, and a passage 36j extending from the exhaust port 36d of the second pump 36 is connected to the toner conveyance passage 28 to thereby form the three-way intersection portion 28d. Here, the intermediate point of the conveyance passage 28 is an intermediate point of the distance from the discharge port 27 of the toner accommodating portion 16 to the receiving port 24 of the developing unit B.

Note that in the present embodiment, the discharge port 27 of the toner storage unit C is disposed at the arrow Y2 in the vertical direction with respect to the receiving port 24 of the developing unit B. Therefore, the shape of the toner conveyance passage 28 extends along the arrow Y2 in the vertical direction first from the discharge port 27 of the toner storage unit C (the region of M1 in the drawing). Then, the shape of the toner conveyance passage 28 extends along the arrow X1 in the horizontal direction (the region of M2 in the drawing) and further extends along the arrow Y1 in the vertical direction (the region of M3 in the drawing). Furthermore, the shape of the toner conveyance passage 28 extends along the arrow X1 in the horizontal direction (the region of M4 in the drawing), finally extends along the arrow Y2 in the vertical direction (the region of M5 in the drawing), and is then connected to the receiving port 24 of the developing unit B.

In order to prevent the toner T inside the developing unit B from leaking to the outside due to an inner pressure rise of the developing unit B when air is sent along with the toner T to the developing unit B, a ventilation member 26 as a ventilation portion is provided in the middle of the toner conveyance passage 28. The ventilation member 26 is configured to allow the air to pass therethrough between the outside and prevent the toner from passing therethrough, and may be configured of a filter that is rough enough to allow the air to pass therethrough while not allowing the toner to pass therethrough, for example. The ventilation member 26 is disposed on the side closer to the developing unit B with reference to the intermediate point (dotted line) 28c of the distance from the discharge port 27 of the toner conveyance passage 28 to the receiving port 24. The three-way intersection portion 28d is located on the side closer to the connecting portion 28a (the discharge port 27, the toner accommodating portion 16) than the intermediate point 28c of the toner conveyance passage 28.

In the present embodiment, the ventilation member 26 is disposed on the upper side (the direction of the arrow Y1 in the drawing) in the vertical direction of the receiving port 24 of the developing unit B. In other words, the passage directed from the location where the ventilation member 26 is provided in the toner conveyance passage 28 to the receiving port 24 is a passage directed downward in the vertical direction. The ventilation member 26 is located on the side further upward in the vertical direction than the connecting portion 28a (discharge port 27).

Note that flows of the air and the toner T at the time of the conveyance of the toner T from the toner storage unit C to the developing unit B will be described later in detail. Note that the ventilation member 26 that allows the air to pass therethrough without allowing the toner T to pass therethrough may be appropriately selected in accordance with the toner T to be used.

Note that as the toner conveyance passage 28, a flexible tube of rubber, a silicone, or the like or a hollow member such as a resin or metal pipe may be appropriately selected. In a case of a configuration in which the toner T is conveyed with an air flow, the toner conveyance passage 28 is not limited to the shape as a combination of the horizontal direction and the vertical direction as in the present embodiment, and it is possible to freely dispose a toner conveyance passage 28 in an oblique direction, with an arc shape, or the like.

### Mechanism of Toner Supply

Next, a mechanism of supply of the toner T from the toner storage unit C to the developing unit B illustrated in FIG. 1 will be described as follows. First, a relationship between the first pump and the second pump and a relationship of ventilation resistances between the ventilation member and the second pump will be described. Then, the toner supply operation will be described separately for three operations from a toner supply operation 1 to a toner supply operation 3.

### Relationship Between First Pump and Second Pump

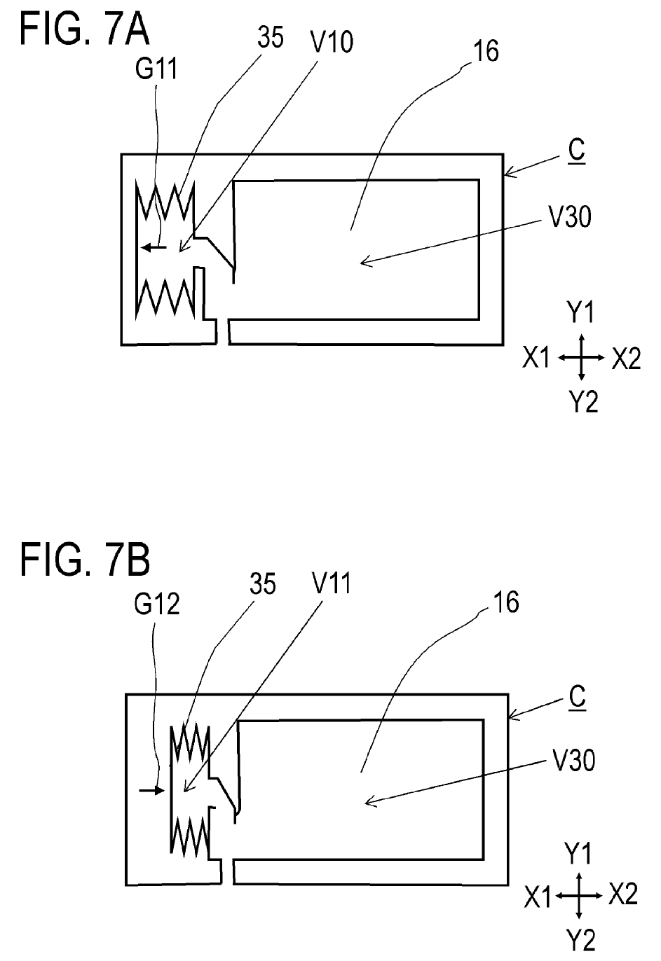

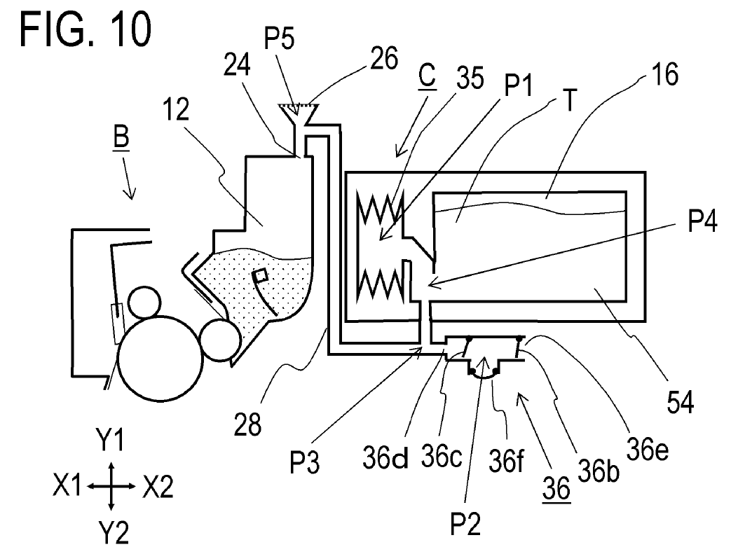

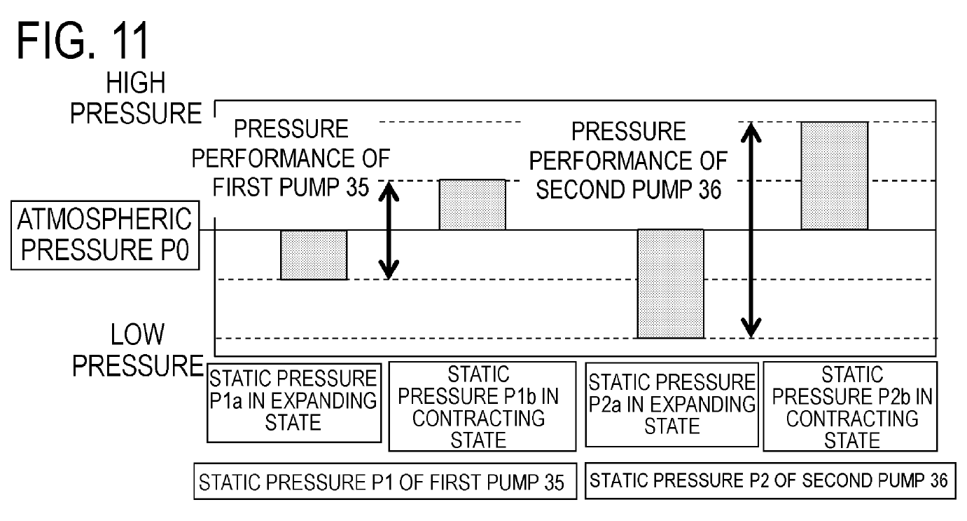

The relationship between the first pump 35 and the second pump 36 will be described using FIGS. 7A and 7B, 8A - 8C, 10, and 11. FIG. 7A is a sectional view in the direction Z2 in a state where the expanding first pump 35 and the toner accommodating portion 16 are connected. FIG. 7B is a sectional view in the direction Z2 in a state where the contracting first pump 35 and the toner accommodating portion 16 are connected. FIG. 10 is a sectional view of the toner storage unit and the developing unit, and is a diagram illustrating sites indicated by a static pressure P1 of the first pump, a static pressure P2 of the second pump, a static pressure P3 of the three-way intersection portion of the toner conveyance passage, a static pressure P4 of the toner storage unit, and a static pressure P5 near the ventilation member 26 inside the toner conveyance passage 28 (hereinafter, referred to as a static pressure P5 in the vicinity of the ventilation member 26). FIG. 11 is a graph illustrating static pressures in volume changed states of the first pump 35 and the second pump 36. The horizontal axis of the graph represents the states of the first pump 35 and the second pump 36, and the vertical axis represents whether the static pressures of the pumps are higher or lower than an atmospheric pressure P0. With reference to the atmospheric pressure P0 of the vertical axis, the bar graph extends upward in a case where the static pressure is high, and the bar graph extends downward in a case where the static pressure is low.

The relationship between the static pressure P1 of the first pump and the static pressure P2 of the second pump illustrated in FIG. 10 will be described in detail using FIG. 11. As illustrated in FIG. 11, a difference of a static pressure P1a of the expanding first pump 35 from the atmospheric pressure P0 is smaller than a static pressure P2a of the expanding second pump 36, and a static pressure P1b of the contracting first pump 35 is smaller than the static pressure P2b of the contracting second pump 36. In this manner, the pressure performance of the first pump 35 is configured to be lower than the second pump 36. The reason for the above matter is as follows.

First, the volume and the inner pressure when the first pump 35 operates will be described. When the volume of the expanding first pump 35 when the volume thereof changes in the pump expanding direction (the direction of the arrow G11) is defined as V10 as illustrated in FIG. 7A, and the volume of the toner accommodating portion is defined as V30, the volume of the toner storage unit C is V10 + V30. Similarly, when the volume of the contracting first pump 35 when the volume thereof changes in the pump contracting direction (the direction of the arrow G12) is defined as V11 as illustrated in FIG. 7B, the volume of the toner storage unit C is V11 + V30.

Here, it is assumed that when the toner storage unit C is a tightly closed system and the initial inner pressure is defined as the atmospheric pressure P0, the volume of the first pump 35 has changed from V10 to V11. According to the Boyle's Law, the static pressure P1b of the contracting first pump 35 after the change in volume is (V10 + V30)/(V11 + V30) × P0. If it is assumed that V10 is 20 ml, V11 is 3 ml, and the volume V30 of the toner accommodating portion is 1000 ml as described above, the static pressure P1b of the contracting first pump 35 is about 1.017 × P0. Since the toner storage unit C is not tightly closed in practice, the static pressure P1b of the contracting first pump 35 is less than this value.

Next, the volume and the inner pressure when the second pump 36 operates will be described. The volume of the expanding second pump when the volume thereof changes in the diaphragm expanding direction (the direction of the arrow G21) as illustrated in FIG. 8B is defined as V20, and the volume of the contracting second pump when the volume thereof changes in the diaphragm contracting direction (the direction of the arrow G22) as illustrated in FIG. 8C is defined as V21.

Here, it is assumed that when the second pump 36 is a tightly closed system, and the initial inner pressure is the atmospheric pressure P0, the volume of the second pump 36 has changed from V20 to V21. According to the Boyle's Law, the static pressure P2b of the contracting second pump 36 after the change in volume is (V20/V21) × P0. As described above, V20 is 2.3 ml, V21 is 2 ml, and the static pressure P2b of the contracting second pump 36 is 1.15 × P0.

Since the first pump 35 is connected to the toner accommodating portion 16 with a large volume in the present embodiment as described above, the difference of the static pressure P1b of the contracting first pump 35 from the atmospheric pressure P0 is smaller than difference of the static pressure P2b of the contracting second pump 36 therefrom. According to similar calculation, the difference of the static pressure P1a of the expanding first pump 35 from the atmospheric pressure P0 is smaller than the difference of the static pressure P2a of the expanding second pump 36 therefrom.

### Relationship of Ventilation Resistances Between Ventilation Member and Second Pump

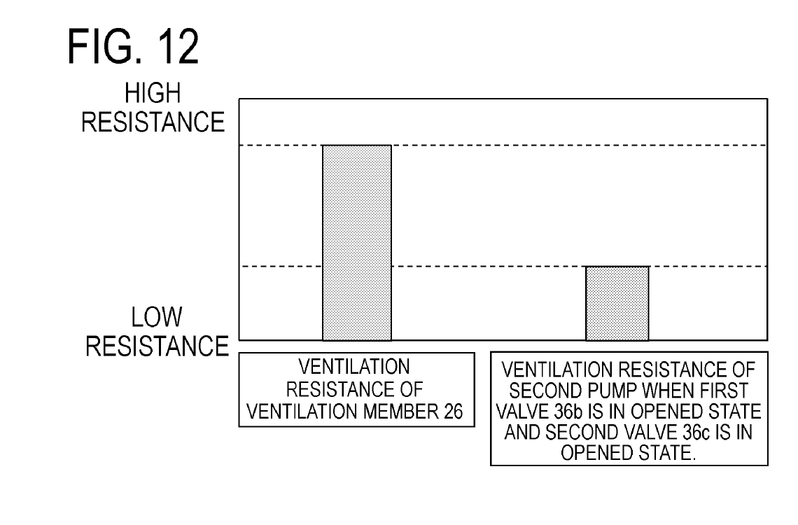

The relationship of the ventilation resistances between the ventilation member 26 and the second pump 36 will be described using FIG. 12. FIG. 12 is a graph illustrating a relationship of the ventilation resistances between the ventilation member 26 and the second pump 36 when the first valve 36b and the second valve 36c are in an opened state. The horizontal axis of the graph represents each configuration, and the vertical axis represents how high the ventilation resistances are.

Since the ventilation member 26 is configured of minute holes through which the toner T cannot pass in the present embodiment, the ventilation resistance of the ventilation member 26 is greater than the ventilation resistance of the second pump 36 when the first valve 36b and the second valve 36c are in the opened state as illustrated in FIG. 12. Setting of the ventilation resistance of the ventilation member 26 can be adjusted by a material, an area, and the like.

### Toner Supply Operation

A supply operation of the toner T from the toner storage unit C to the developing unit B will be described.

In the supply operation of the toner T from the toner storage unit C to the developing unit B illustrated in FIG. 1, the toner T in the toner accommodating portion 16 of the toner storage unit C is conveyed to the developing unit B via the toner conveyance passage 28 with an air flow. At this time, operations of the first pump 35 and the second pump 36 are performed in accordance with the following operations.
Toner supply operation 1: In this operation, the first pump 35 is stopped, while the second pump 36 is operating.
Toner supply operation 2: In this operation, both the first pump 35 and the second pump 36 are operating.
Toner supply operation 3: In this operation, the first pump 35 is stopped, while the second pump 36 is operating (the same as the toner supply operation 1).
Hereinafter, the toner supply operation 1 to the toner supply operation 3 will be described in order.

### Toner Supply Operation 1

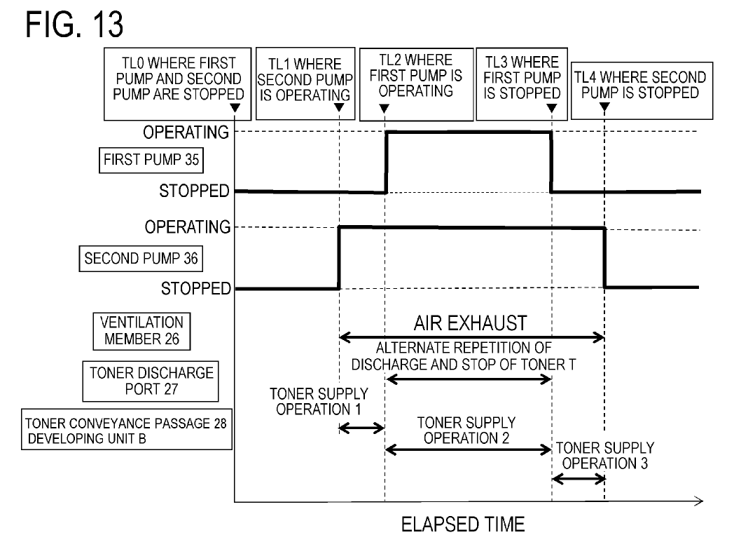

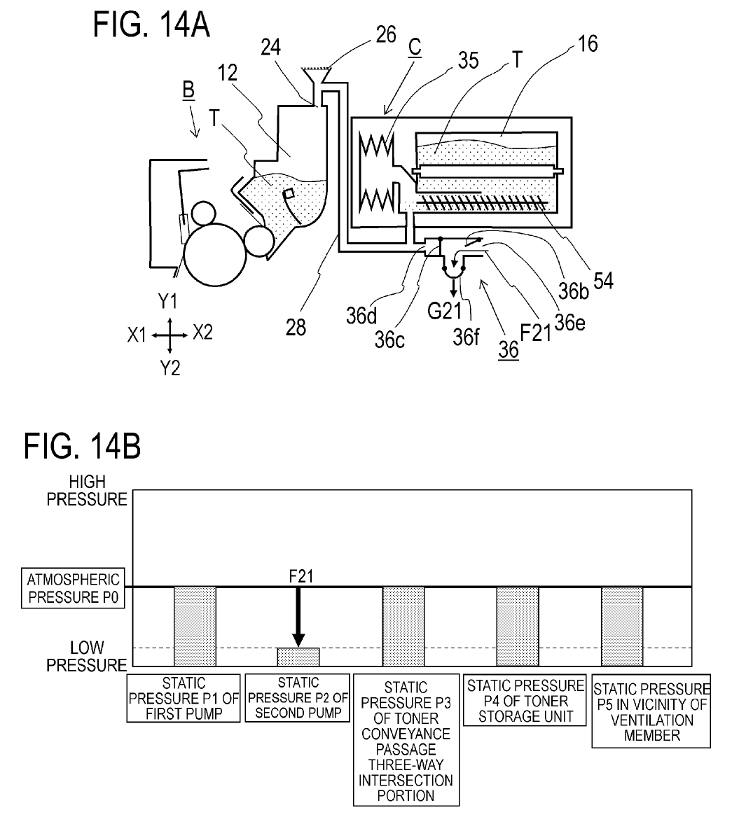

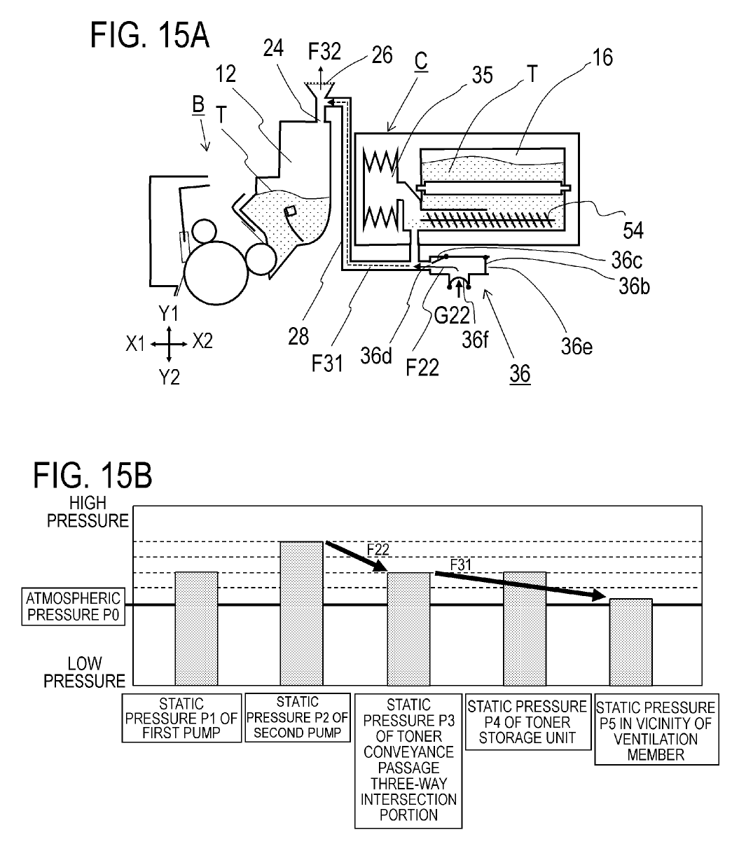

First, the toner supply operation 1 will be described using FIGS. 8A, 10, 13, 14A, 14B, 15A, and 15B. FIG. 13 is a conceptual diagram illustrating timings of the operations of the first pump 35 and the second pump 36. FIG. 14A is a sectional view seen in the direction Z1 when the first pump 35 is stopped and the second pump 36 is performing the expanding operation. FIG. 14B is a graph illustrating relationships between the static pressures at the first pump 35 and the second pump 36 in the first pump state, the three-way intersection portion 28d of the toner conveyance passage 28, and the toner storage unit C, and near the ventilation member 26 of the toner conveyance passage 28 and the atmospheric pressure. FIG. 15A is a sectional view seen in the direction Z1 when the first pump 35 is stopped and the second pump 36 is performing the contracting operation. FIG. 15B is a graph illustrating relationships between the static pressures at the first pump 35 and the second pump 36 in the second pump state, the three-way intersection portion 28d of the toner conveyance passage 28, and the toner storage unit C and near the ventilation member 26 of the toner conveyance passage 28 and the atmospheric pressure.

An air flow generated by magnitude relationships of the static pressures P1 to P5 illustrated in FIG. 10 and determined by the operation states of the first pump 35 and the second pump 36 in the toner supply operation 1 will be described.

In a state of TL0 where the first pump 35 is stopped and the second pump 36 is also stopped as illustrated in FIG. 13, the second pump 36 is in the above-described state illustrated in FIG. 8A.

Next, when a state TL1 is achieved, a state where the first pump 35 is stopped and only the second pump 36 is operating is achieved. In this state, the state where the first pump 35 is stopped and the second pump 36 is performing the expanding operation as illustrated in FIG. 14A and the state where the first pump 35 is stopped and the second pump 36 is performing the contracting operation as illustrated in FIG. 15A are alternately repeated. Hereinafter, the state in FIG. 14A will be referred to as the first pump state, and the state in FIG. 15A will be referred to as the second pump state.

Furthermore, since the first pump 35 is not operating in the first pump state in FIG. 14A and the second pump state in FIG. 15A, the toner T is not discharged from the toner storage unit C.

In the first pump state, the static pressure P2 is lower than the atmospheric pressure P0 since the second pump 36 is performing the expanding operation as illustrated in FIG. 14B. Therefore, since the first valve 36b is biased in the direction X1, and the second valve 36c is biased in the direction X2 as illustrated in FIG. 14A, the first valve 36b is brought into the opened state, and the second valve 36c is brought into the closed state. In this manner, an air flow (the direction of the arrow F21) is generated on the side of the static pressure P2 (inside the second pump 36) that is lower than the atmospheric pressure P0.

On the other hand, the static pressure P1 of the first pump 35, the static pressure P3 of the three-way intersection portion 28d of the toner conveyance passage 28, the static pressure P4 of the toner storage unit C, and the static pressure P5 in the vicinity of the ventilation member 26 are substantially equal to the atmospheric pressure P0 in this state, and no air flow is generated.

In the second pump state, the static pressure P2 is higher than the atmospheric pressure P0 since the second pump 36 is performing the contracting operation as illustrated in FIG. 15B. Therefore, since the first valve 36b is biased in the direction X2, and the second valve 36c is biased in the direction X1 as illustrated in FIG. 15A, the first valve 36b is brought into the closed state, and the second valve 36c is brought into the opened state. In this manner, an air flow (the direction of the arrow F22) directed from the exhaust port 36d of the second pump 36 to the toner conveyance passage 28 is generated.

Here, since the toner storage unit C is tightly closed, and the first pump 35, the toner storage unit C, and the three-way intersection portion 28d communicate with each other, the static pressure P4 of the toner storage unit C and the static pressure P1 of the first pump 35 are substantially equal to the static pressure P3 of the three-way intersection portion 28d of the toner conveyance passage 28. On the other hand, the ventilation member 26 is formed of a material with air permeability, and the static pressure P5 in the vicinity of the ventilation member 26 is thus lower than the static pressure P3 of the three-way intersection portion 28d of the toner conveyance passage 28. Therefore, an air flow (the direction of the arrow F31) directed to the ventilation member 26 is generated, and the air is exhausted to the outside through the ventilation member 26 (the direction of the arrow F32).

In this manner, the toner T in the toner storage unit C is not conveyed to the developing unit B between TL1 and TL2 illustrated in FIG. 13, the air in the second pump 36 flows in the direction of the ventilation member 26 from the toner conveyance passage 28 and is then exhausted to the outside from the ventilation member 26.

### Toner Supply Operation 2

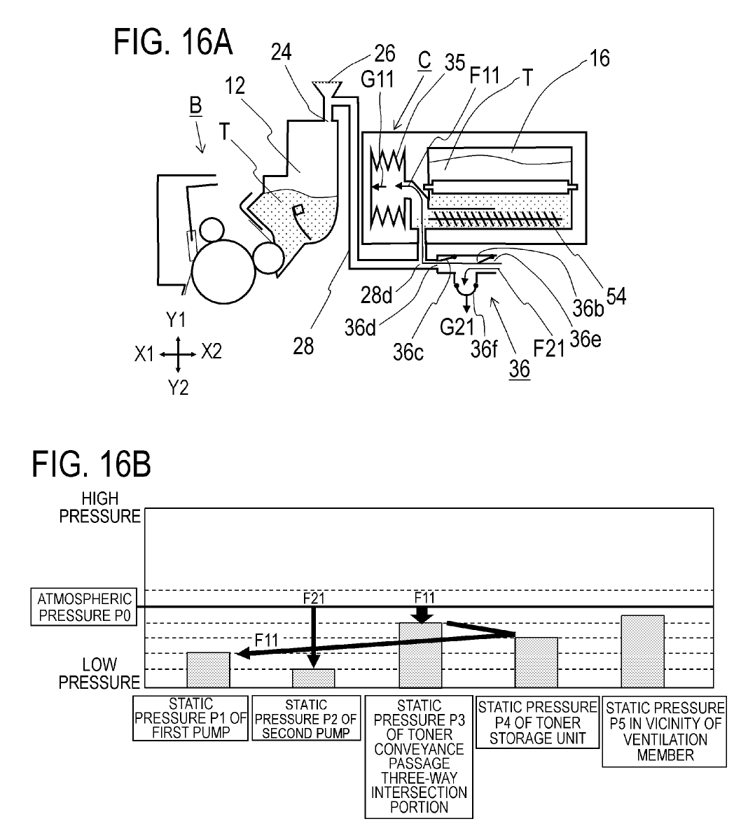

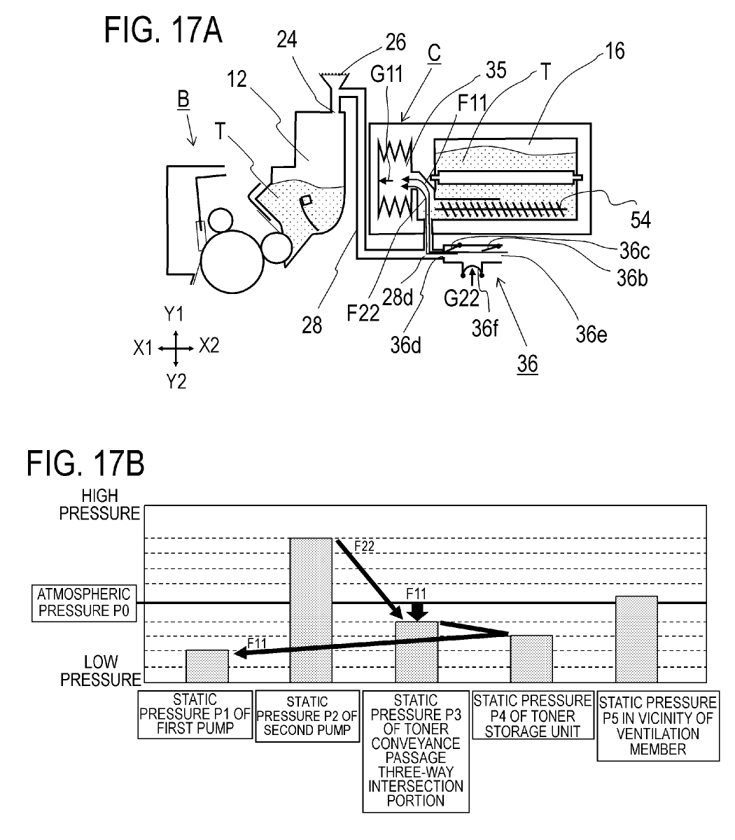

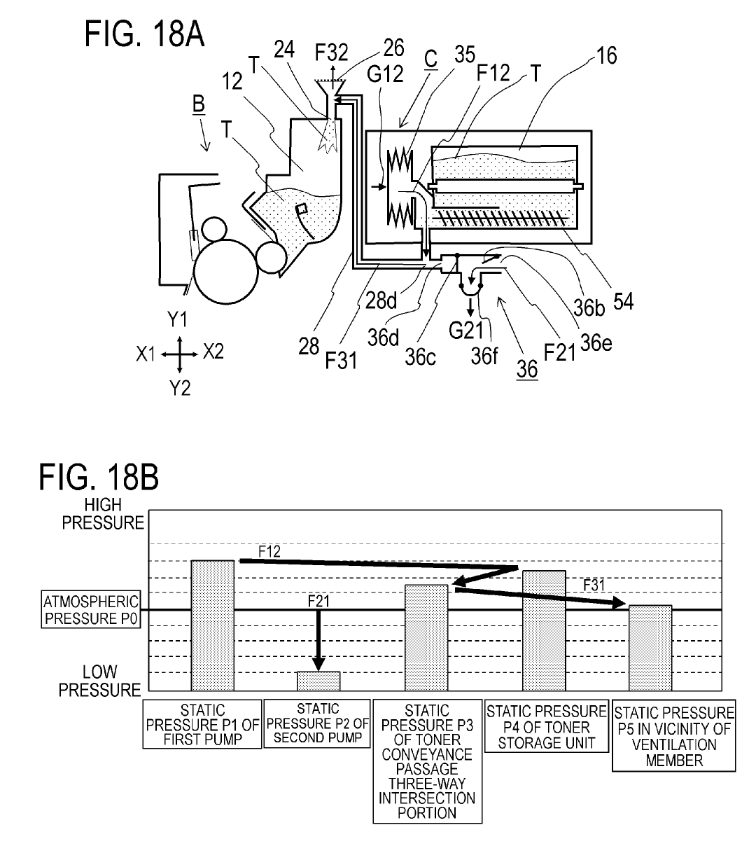

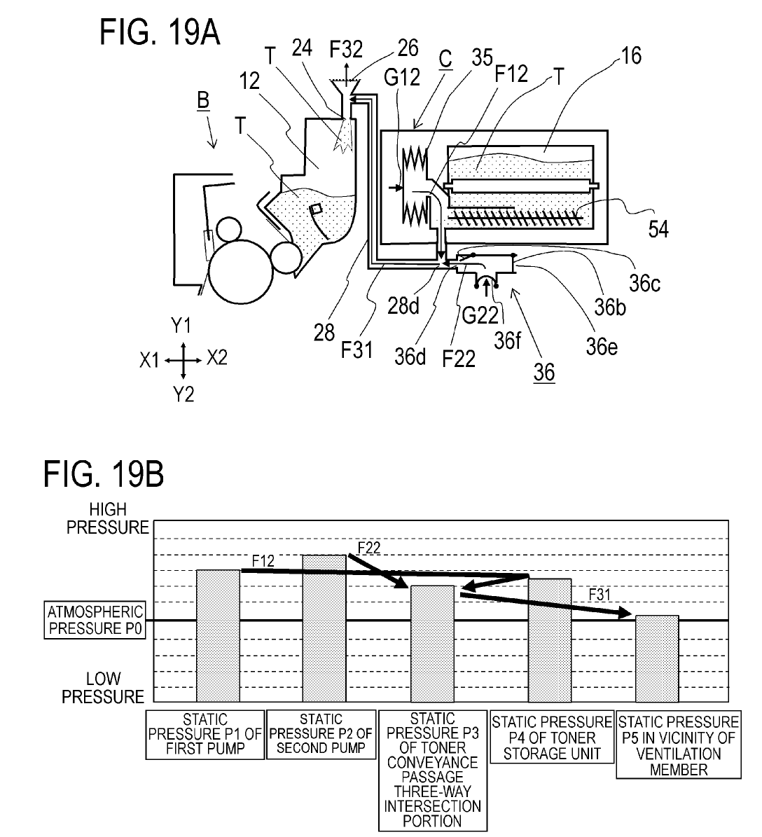

Next, the toner supply operation 2 will be described using FIGS. 10, 11, 13, 16A, 16B, 17A, 17B, 18A, 18B, 19A, and 19B. FIG. 16A is a sectional view seen in the direction Z1 when the first pump 35 is performing the expanding operation and the second pump 36 is performing the expanding operation. FIG. 16B is a graph illustrating relationships between the static pressures at the first pump 35 and the second pump 36 in the third pump state, the three-way intersection portion 28d of the toner conveyance passage 28, and the toner storage unit C and near the ventilation member 26 of the toner conveyance passage 28 and the atmospheric pressure. FIG. 17A is a sectional view seen in the direction Z1 when the first pump 35 is performing the expanding operation and the second pump 36 is performing the contracting operation. FIG. 17B is a graph illustrating relationships between the static pressures at the first pump 35 and the second pump 36 in the fourth pump state, the three-way intersection portion 28d of the toner conveyance passage 28, and the toner storage unit C and near the ventilation member 26 of the toner conveyance passage 28 and the atmospheric pressure. FIG. 18A is a sectional view seen in the direction Z1 when the first pump 35 is performing the contracting operation and the second pump 36 is performing the expanding operation. FIG. 18B is a graph illustrating relationships between the static pressures at the first pump 35 and the second pump 36 in the fifth pump state, the three-way intersection portion 28d of the toner conveyance passage 28, and the toner storage unit C, and near the ventilation member 26 of the toner conveyance passage 28 and the atmospheric pressure. FIG. 19A is a sectional view seen in the direction Z1 when the first pump 35 is performing the contracting operation and the second pump 36 is performing the contracting operation. FIG. 19B is a graph illustrating relationships between the static pressures at the first pump 35 and the second pump 36 in the sixth pump state, the three-way intersection portion 28d of the toner conveyance passage 28, and the toner storage unit C, and near the ventilation member 26 of the toner conveyance passage 28 and the atmospheric pressure.

An air flow generated by magnitude relationships of the static pressures P1 to P5 illustrated in FIG. 10 and determined by the operation states of the first pump 35 and the second pump 36 in the toner supply operation 2 will be described.

If a state TL2 is achieved as illustrated in FIG. 13, then a state where the first pump 35 is operating and the second pump 36 is also operating is achieved. In this state, there are a state where the first pump 35 is performing the expanding operation and the second pump 36 is performing the expanding operation as illustrated in FIG. 16A and a state where the first pump 35 is performing the expanding operation and the second pump 36 is performing the contracting operation as illustrated in FIG. 17A. In other words, the first pump 35 is in a first air intake state where an air intake flow directed from the discharge port 27 to the inside of the toner accommodating portion 16 is generated when the first pump 35 is performing the expanding operation. Although the second pump 36 repeats the expanding operation (FIG. 16A) and the contracting operation (FIG. 17A), the second pump 36 is in the third air intake state where the second pump 36 establishes communication between the inside of the toner conveyance passage 28 and the external air via the three-way intersection portion 28d as a connecting portion during any of these operations.

Furthermore, either a state where the first pump 35 is performing the contracting operation and the second pump 36 is performing the expanding operation as illustrated in FIG. 18A or a state where the first pump 35 is performing the contracting operation and the second pump 36 is performing the contracting operation as illustrated in FIG. 19A is achieved. In other words, the first pump 35 is in a first exhaust state where an exhaust flow directed from the inside of the toner accommodating portion 16 to the discharge port 27 is generated when the first pump 35 is performing the contracting operation. Also, the second pump 36 is in a second air intake state in which the external air is taken when the second pump 36 is performing the expanding operation (FIG. 18A) and is in a second exhaust state where the air is exhausted to the inside of the toner conveyance passage 28 via the three-way intersection portion 28d as a connecting portion when the second pump 36 is performing the contracting operation (FIG. 19A).

The toner supply operation 2 (developer supply operation) can be executed by the first pump 35 repeating the first exhaust state and the first air intake state and by the second pump 36 repeating the second exhaust state, the second air intake state, and the third air intake state. Hereinafter, the state in FIG. 16A will be referred to as the third pump state, the state in FIG. 17A will be referred to as the fourth pump state, the state in FIG. 18A will be referred to as the fifth pump state, and the state in FIG. 19A will be referred to as the sixth pump state.

Next, operations in the pump third state and an air flow generated therethrough will be described. In the third pump state, the second pump 36 is performing the expanding operation as illustrated in FIG. 16B, and the static pressure P2 is thus lower than the atmospheric pressure P0. In this manner, the first valve 36b is biased in the direction X1 and is brought into the opened state as illustrated in FIG. 16A, and an air flow (the direction of the arrow F21) entering the second pump 36 is generated. Similarly, the first pump 35 is performing the expanding operation as illustrated in FIG. 16B, and the static pressure P1 is thus lower than the atmospheric pressure P0. In this manner, the second valve 36c is biased in the direction X1 and is brought into the opened state as illustrated in FIG. 16A, and an air flow (the direction of the arrow F11) entering the first pump 35 is generated.

In other words, an air flow in a direction opposite to the direction in which the toner T is discharged from the toner storage unit C to the conveyance passage 28 is generated. Therefore, the toner T is not discharged from the toner storage unit C in the third pump state.

Next, operations in the fourth pump state and an air flow generated therethrough will be described.

In the fourth pump state, the first pump 35 is performing the expanding operation as illustrated in FIG. 17B, and the static pressure P1 is thus lower than the atmospheric pressure P0. Also, the second pump 36 is performing the contracting operation, and the static pressure P2 thus increases. In this manner, the second valve 36c is biased in the direction X1 and is thus brought into the opened state as illustrated in FIG. 17A, and an air flow (the direction of the arrow F22) exhausted from the second pump 36 and directed to the first pump 35 is generated. Next, since the second pump 36 is performing the contracting operation while the second valve 36c is in the opened state as illustrated in FIG. 17B, the static pressure P2 is lower than the atmospheric pressure P0. In this manner, the first valve 36b is brought into the opened state as illustrated in FIG. 17A, and an air flow (the direction of the arrow F11) entering the first pump 35 from the outside is generated.

In other words, similarly to the third pump state, an air flow in the direction opposite to the direction in which the toner T is discharged from the toner storage unit C to the conveyance passage 28 is generated. Therefore, the toner T is not discharged from the toner storage unit C in the fourth pump state.

Next, operations in the fifth pump state and flows of the air and the toner T generated therethrough will be described.

In the fifth pump state, the static pressure P1 is higher than the atmospheric pressure P0 because the first pump 35 is performing the contracting operation, and the static pressure P2 is lower than the atmospheric pressure P0 because the second pump 36 is performing the expanding operation, as illustrated in FIG. 18B. Therefore, the first valve 36b is biased in the direction X1 and is brought into the opened state, and the second valve 36c is biased in the direction X2 and is brought into the closed state, as illustrated in FIG. 18A. In this manner, an air flow (the direction of the arrow F21) is generated on the side of the static pressure P2 (inside the second pump 36) that is lower than the atmospheric pressure P0. Also, the static pressure P1 is relatively high, and an air flow (the direction of the arrow F12) directed from the first pump 35 to the three-way intersection portion 28d of the toner conveyance passage 28 is generated. The toner T in the toner storage unit C is discharged to the three-way intersection portion 28d together with the air flow. Then, since the second valve 36c is in the closed state as illustrated in FIG. 18A, and the static pressure P5 in the vicinity of the ventilation member 26 is relatively low, a mixed air of the air and the toner T is directed to the ventilation member 26 (the direction of the arrow F31). Then, only the air is exhausted to the outside of the toner conveyance passage 28 through the ventilation member 26 (the direction of the arrow F32), and the toner T and the air are separated. The separated toner T drops to the receiving port 24 of the developing unit B due to a gravity and is then supplied to the developing unit B.

In this manner, the toner T is conveyed to the developing unit B with the air flow generated by the contracting operation of the first pump 35 in the fifth pump state.

Next, operations in the sixth pump state and flows of the air and the toner T generated therethrough will be described.

In the sixth pump state, the first pump 35 and the second pump 36 are performing the contracting operation as illustrated in FIG. 19B, and the static pressure P1 and the static pressure P2 are thus higher than the atmospheric pressure P0. Therefore, the first valve 36b is biased in the direction X2 and is brought into the closed state as illustrated in FIG. 19A. On the other hand, the direction in which the second valve 36c is to be biased depends on the magnitude relationship between the static pressure P1 of the first pump 35 and the static pressure P2 of the second pump 36, and the static pressure P2 is greater as illustrated in FIG. 11. Therefore, the second valve 36c is biased in the direction X1 and is brought into the opened state.

Therefore, air (the direction of the arrow F12) directed from the first pump 35 to the three-way intersection portion 28d of the toner conveyance passage 28 is generated, and the toner T in the toner storage unit C is thus mixed and discharged with the air to the three-way intersection portion 28d. Also, an air flow (the direction of the arrow F22) is generated from the exhaust port 36d of the second pump 36 to the three-way intersection portion 28d of the toner conveyance passage 28.

As illustrated in FIG. 19A, the flow of the mixed air of the air and the toner T (the direction of the arrow F12) is merged with the flow (the direction of the arrow F22) of the air from the second pump 36 at the three-way intersection portion 28d of the toner conveyance passage 28. The mixed air of the merged air and the toner T is directed to the ventilation member 26 (the direction of the arrow F31) since the static pressure P5 in the vicinity of the ventilation member 26 is relatively low. Then, only the air is exhausted to the outside of the toner conveyance passage 28 through the ventilation member 26 (the direction of the arrow F32), and the toner T and the air are separated similarly to the fifth pump state. The separated toner T drops to the receiving port 24 of the developing unit B due to a gravity and is then supplied to the developing unit B.

Therefore, the toner T is conveyed to the developing unit B with the air flow generated by the contracting operations of the first pump 35 and the second pump 36 in the sixth pump state.

### Toner Supply Operation 3

The toner supply operation 3 will be described using FIG. 13.

As illustrated in FIG. 13, once the state TL4 is achieved from TL3, a state where the first pump state and the second pump state are alternately repeated is achieved similarly to the above-described toner supply operation 1. The toner T is not conveyed to the developing unit B, and the air in the second pump 36 flows in the direction of the ventilation member 26 from the toner conveyance passage 28 and is then exhausted from the ventilation member 26 to the outside.

In this manner, the toner T remaining in the toner conveyance passage 28 is conveyed to the developing unit B by sending air with no toner T mixed therein to the toner conveyance passage 28 in the toner supply operation 3 after the toner supply operation 2.

Once a state TL4 after elapse of a predetermined period of time is achieved from TL3, the second pump 36 is stopped, and the series of operations of conveying the toner T from the toner storage unit C to the developing unit B are ended.

### Relationship of Flow Amounts Between First Pump and Second Pump in Toner Supply Operation 2

Next, a relationship of the flow amount of air exhausted from the first pump 35 and the flow amount of the air exhausted from the second pump 36 in the toner supply operation 2 will be described using FIGS. 19A and 19B.

Both the first pump 35 and the second pump 36 exhaust air in the toner supply operation 2 as described above at the time of the sixth pump state illustrated in FIG. 19A. If the inner pressure before the contracting operation is assumed to be the atmospheric pressure P0, the static pressure P1b of the contracting first pump 35 is about 1.017 × P0 at maximum as described above in <Relationship between First Pump and Second Pump>. Similarly, the static pressure P2b of the contracting second pump 36 is about 1.15 × P0 at maximum. In other words, the pressure generated by the second pump 36 in the second exhaust state is higher than the pressure generated by the first pump 35 in the first exhaust state during the toner supply operation 2. In practice, if the second pump 36 is not a tightly closed system and the inner pressure of the second pump 36 is higher than the pressure outside the second valve 36c, then the second valve 36c is brought into the opened state. In other words, since the static pressure P2b of the contracting second pump 36 is higher than the static pressure P1b of the contracting first pump 35 in the present embodiment, the second valve 36c is brought into the opened state. Therefore, it is possible to form the air flow F12 of the exhaust of the first pump 35 and the air flow F22 of the exhaust of the second pump 36.

Here, if it is assumed that the first pump 35 performs, 2.5 times per second, a volume change of 17 ml ((V10 + V30) - (V11 + V30)) as described above, then the flow amount of the air flow (the direction of the arrow F12) of the exhaust of the first pump 35 is 42.5 ml/sec. Similarly, if it is assumed that the second pump 36 performs, 20 times per second, a volume change of 0.3 ml (V20 - V21), then the flow amount of the air flow F22 of the exhaust of the second pump 36 is 6 ml/sec. In other words, the flow amount of air per unit time sent by the second pump 36 to the toner conveyance passage 28 during the toner supply operation 2 is smaller than the flow amount of air per unit time sent by the first pump 35 to the toner conveyance passage 28. Also, the amount of change in volume of the second pump 36 between the second exhaust state (FIG. 8C) and the second air intake state (FIG. 8B) is smaller than the amount of change in volume of the first pump 35 between the first exhaust state (FIG. 7B) and the first air intake state (FIG. 7A). Also, the number of times per unit time the second pump 36 repeats the second exhaust state and the second air intake state during the toner supply operation 2 is greater than the number of times per unit time the first pump 35 repeats the first exhaust state and the first air intake state.

It is possible to perform the above-described toner supply operation 2 under a condition that the flow amount of air exhausted from the second pump 36 is smaller than the flow amount of air exhausted from the first pump 35 by appropriately setting the volume V10 of the expanding first pump and the volume V11 of the contracting first pump, the volume V30 of the toner accommodating portion connected to the first pump, and the volume V20 of the expanding second pump and the volume V21 of the contracting second pump as described above.

As described above, according to the present embodiment, it is possible to supply the toner T immediately from the toner storage unit C in accordance with the amount of toner T consumed by the developing unit B in the above-described toner supply operations, to completely send the toner T discharged from the toner storage unit C to the developing unit B, and to thereby reduce the toner T accumulated in the toner conveyance passage 28 as much as possible. Furthermore, it is possible to curb inhibition of the air flow (the direction of the arrow F12) due to the exhausting operation of the first pump 35 by the air flow (the direction of the arrow F22) due to the exhausting operation of the second pump by setting the flow amount of the air exhausted from the second pump 36 to be smaller than the flow amount of air exhausted from the first pump 35 during the toner supply operations. It is thus possible to curb a decrease in amount of toner T discharged from the toner storage unit C along with the air flow (the direction of the arrow F12) due to the exhausting operation of the first pump 35.

Although the image forming apparatus IF according to the present embodiment has a configuration including one set of the toner storage unit C and the developing unit B, a similar effect can also be obtained by an image forming apparatus including a plurality of sets thereof like a color laser printer or the like.

According to the present disclosure, it is possible to curb occurrence of an image failure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069555, filed on Apr. 21, 2025, which is hereby incorporated by reference herein in its entirety.

What is claimed is:

1. An image forming apparatus comprising:
a developer storage unit that includes a developer accommodating portion and a discharge port that discharges developer accommodated in the developer accommodating portion;
an image bearing member on which an electrostatic latent image is formed;
a developing unit that develops the electrostatic latent image using the developer supplied from the developer storage unit;
a conveyance passage that connects the discharge port and the developing unit;
a first pump that is connected to the developer storage unit and discharges, to the developer storage unit, air for discharging the developer from the developer storage unit to the conveyance passage via the discharge port; and
a second pump that is connected between the discharge port and the developing unit in the conveyance passage and discharges air to the conveyance passage,
wherein
the developer discharged to the conveyance passage together with the air discharged from the first pump is conveyed to the developing unit through inside of the conveyance passage together with the air discharged from the second pump, and
in a case where the developer is conveyed to the developing unit, an amount of air discharged from the second pump is smaller than an amount of air discharged from the first pump.

2. The image forming apparatus according to claim 1,
wherein the first pump is configured to be brought into a first air intake state and a first exhaust state, the first air intake state being a state where an air intake flow directed from the discharge port to inside of the developer accommodating portion is generated, the first exhaust state being a state where an exhaust air flow directed from the inside of the developer accommodating portion to the discharge port is generated,
wherein the second pump is connected to the conveyance passage at a connecting portion between the discharge port and the developing unit in the conveyance passage and is configured to be able to communicate with external air, is able to be brought into a second air intake state where the external air is taken and a second exhaust state where air is exhausted to inside of the conveyance passage in a case where the first pump is in the first exhaust state, and is able to be brought into a third air intake state where communication is established between the inside of the conveyance passage and the external air in a case where the first pump is in the first air intake state,
wherein a developer supplying operation of supplying the developer from the developer accommodating portion to the developing unit via the conveyance passage is able to be executed by the first pump repeating the first exhaust state and the first air intake state and by the second pump repeating the second exhaust state, the second air intake state, and the third air intake state, and
wherein an amount of air flow per unit time fed by the second pump in the second exhaust state to the conveyance passage via the connecting portion is smaller than an amount of air flow per unit time fed by the first pump in the first exhaust state to the conveyance passage via the discharge port in the developer supply operation.

3. The image forming apparatus according to claim 2,
wherein a pressure generated by the second pump in the second exhaust state is higher than a pressure generated by the first pump in the first exhaust state.

4. The image forming apparatus according to claim 3,
wherein an amount of change in volume of the second pump between the second exhaust state and the second air intake state is smaller than an amount of change in volume of the first pump between the first exhaust state and the first air intake state.

5. The image forming apparatus according to claim 4,
wherein the number of times per unit time the second pump repeats the second exhaust state and the second air intake state is greater than the number of times per unit time the first pump repeats the first exhaust state and the first air intake state in the developer supply operation.

6. The image forming apparatus according to claim 2, further comprising:
a ventilation portion configured to allow air to pass therethrough between outside and prevent the developer from passing therethrough,
wherein the ventilation portion is located on a side closer to the developing unit than an intermediate point between the developer accommodating portion and the developing unit in the conveyance passage, and
wherein the connecting portion is located on a side closer to the developer accommodating portion than the intermediate point in the conveyance passage.

7. The image forming apparatus according to claim 6,
wherein a passage directed from the ventilation portion to the developing unit in the conveyance passage is a passage directed downward in a vertical direction.

8. The image forming apparatus according to claim 7,
wherein the ventilation portion is located on a side further upward than the discharge port.

9. The image forming apparatus according to claim 2,
wherein the first pump includes a first volume changing portion that communicates with inside of the developer accommodating portion and is configured to be able to be brought into the first exhaust state and the first air intake state by the first volume changing portion changing a volume.

10. The image forming apparatus according to claim 9,
wherein the first pump is a bellows pump.

11. The image forming apparatus according to claim 2,
wherein the second pump includes
an external air passage that includes an air intake port that is opened to external air and connects the air intake port and the connecting portion,
a second volume changing portion that is provided in the middle of the external air passage,
a first valve that is provided between the air intake port and the second volume changing portion in the external air passage, the first valve being configured to be able to be brought into an opened state where an air intake flow directed from the air intake port to the second volume changing portion is formed and a closed state where the external air passage is closed, and
a second valve that is provided between the second volume changing portion and the connecting portion in the external air passage, the second valve being configured to be able to be brought into an opened state where an exhaust air flow directed from the second volume changing portion to the connecting portion is formed and a closed state where the external air passage is closed,
wherein the second pump is configured to be able to be brought into the second air intake state, the second exhaust state, and the third air intake state by the second volume changing portion changing a volume.

12. The image forming apparatus according to claim 11, further comprising:
a ventilation portion configured to allow air to pass therethrough between outside and prevent the developer from passing therethrough,
wherein the ventilation portion is located on a side closer to the developing unit than an intermediate point between the developer accommodating portion and the developing unit in the conveyance passage, and
wherein a ventilation resistance of the ventilation portion is higher than a ventilation resistance of the second pump.

13. The image forming apparatus according to claim 11,
wherein the second pump is a diaphragm pump.

14. The image forming apparatus according to claim 2,
wherein the developer storage unit includes
a stirring member that rotates inside the developer accommodating portion and stirs the developer accommodated in the developer accommodating portion, and
a screw that rotates inside the developer accommodating portion and forms a flow of the developer directed to the discharge port inside the developer accommodating portion.

15. The image forming apparatus according to claim 1, further comprising:
an apparatus main body in which the image bearing member, the developing unit, the conveyance passage, and the second pump are provided,
wherein the developer storage unit and the first pump are configured to be removably attached to the apparatus main body.
